(19) United States
(12) Patent Application Publication
(10) Pub. No.: US 2008/0259266 A1
(43) Pub. Date: Oct. 23, 2008

(54) SEALANT, LIQUID CRYSTAL DISPLAY HAVING THE SAME, AND METHOD OF FABRICATING LIQUID CRYSTAL DISPLAY

(75) Inventors: So-Youn PARK, Suwon-si (KR); Nam-Seok Lee, Suwon-si (KR); Il-Kook Huh, Yongin-si (KR); Duck-Jong Suh, Seoul (KR)

Correspondence Address: H.C. PARK & ASSOCIATES, PLC, 8500 LEESBURG PIKE, SUITE 7500, VIENNA, VA, 22182, US

(73) Assignee: Samsung Electronics Co., Ltd., Suwon-si (KR)

(21) Appl. No.: 11/970,280

(22) Filed: Jan. 7, 2008

(30) Foreign Application Priority Data
Apr. 23, 2007 (KR) 10-2007-0039420

(51) Int. Cl. G02F 1/1339; C08F 283/00; B29C 65/54

(52) U.S. Cl. 349/153; 525/471; 156/107

(57) ABSTRACT

A sealant includes a thermosetting agent and a cured resin. The thermosetting agent includes a dihydrazide compound, which has a carbon chain with 5 or less carbon atoms. A liquid crystal display includes a first substrate, a second substrate facing the first substrate, liquid crystal molecules interposed between the first and second substrates, and a sealing pattern disposed along a peripheral portion of the first substrate to couple the first and second substrates. The sealing pattern is includes the sealant. A method for fabricating a liquid crystal display includes forming a sealant pattern by coating the sealant along a peripheral portion of a first substrate, aligning a second substrate on the first substrate, and curing the sealing pattern.

### CROSS-REFERENCE TO RELATED APPLICATION

This application claims priority from and the benefit of Korean Patent Application No 10-2007-0039420, filed on Apr. 23, 2007, which is hereby incorporated by reference for all purposes as if fully set forth herein.

### BACKGROUND OF THE INVENTION

1. Field of the Invention

The present invention relates to a sealant, a liquid crystal display having the same, and a method of fabricating the liquid crystal display. More particularly, the present invention relates to a sealant suitable for displaying a high-quality image, a liquid crystal display having the same, and a method of fabricating the liquid crystal display.

2. Discussion of the Background

In general, a display apparatus may include a liquid crystal display (LCD), a plasma display panel, or an organic electroluminescence display. The display apparatus may be included in various apparatuses for displaying an image, for example, the display apparatus may be a monitor of a large-sized TV or a notebook computer or a screen of a cellular phone.

The display apparatus may include a pair of substrates facing each other. For example, an LCD includes two substrates facing each other with a liquid crystal layer interposed therebetween. An electric field is applied to the liquid crystal layer, which changes the alignment of liquid crystal molecules therein, thereby displaying an image.

The region where the image is displayed is defined as a display area. The display area is positioned in the centers of the two substrates and does not include the peripheral portions of the two substrates. A sealant pattern is formed in the peripheral portions of the substrates to couple the two substrates.

The sealant pattern may include various compounds. Some of the compounds may influence the alignment of the liquid crystal molecules positioned adjacent to the compounds. As a result, the image quality in the area corresponding to the compounds may deteriorate.

### SUMMARY OF THE INVENTION

The present invention provides a sealant suitable for displaying a high-quality image.

The present invention also provides a liquid crystal display including the sealant.

The present invention further provides a method of fabricating the liquid crystal display.

Additional features of the invention will be set forth in the description which follows, and in part will be apparent from the description, or may be learned by practice of the invention.

The present invention discloses a sealant including a thermosetting agent and a cured resin. The thermosetting agent includes a dihydrazide compound, which has a hydrocarbon chain with 5 or less carbon atoms

The present invention also discloses a liquid crystal display including a first substrate, a second substrate facing the first substrate, liquid crystal molecules interposed between the first and second substrates, and a sealing pattern disposed along a peripheral portion of the first substrate to couple the first and second substrates. The sealing pattern is formed from a sealant, and the sealant includes a thermosetting agent comprising a dihydrazide compound, which has a hydrocarbon chain with 5 or less carbons, and a cured resin.

The present invention also discloses a method including coating a sealant along a peripheral portion of a first substrate to form a sealant pattern, disposing liquid crystal molecules on the first substrate, aligning a second substrate on the first substrate, and curing the sealing pattern to couple the first and second substrates. The sealant includes a thermosetting agent including a dihydrazide compound, which has a hydrocarbon chain with 5 or less carbon atoms, and a cured resin.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is an exploded perspective view of an LCD according to an exemplary embodiment of the present invention.

FIG. 2 is a sectional view showing a boundary portion of a display area of an LCD shown in FIG. 1.

FIG. 3A, FIG. 3B, FIG. 3C, FIG. 3D, and FIG. 3E are enlarged photographic views showing boundary portions of display areas of LCDs according to exemplary embodiments and comparative examples of the prevent invention.

FIG. 4A, FIG. 4B, FIG. 4C, FIG. 4D, and FIG. 4E are views showing a procedure for fabricating the liquid crystal display shown in FIG. 1.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the sizes and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

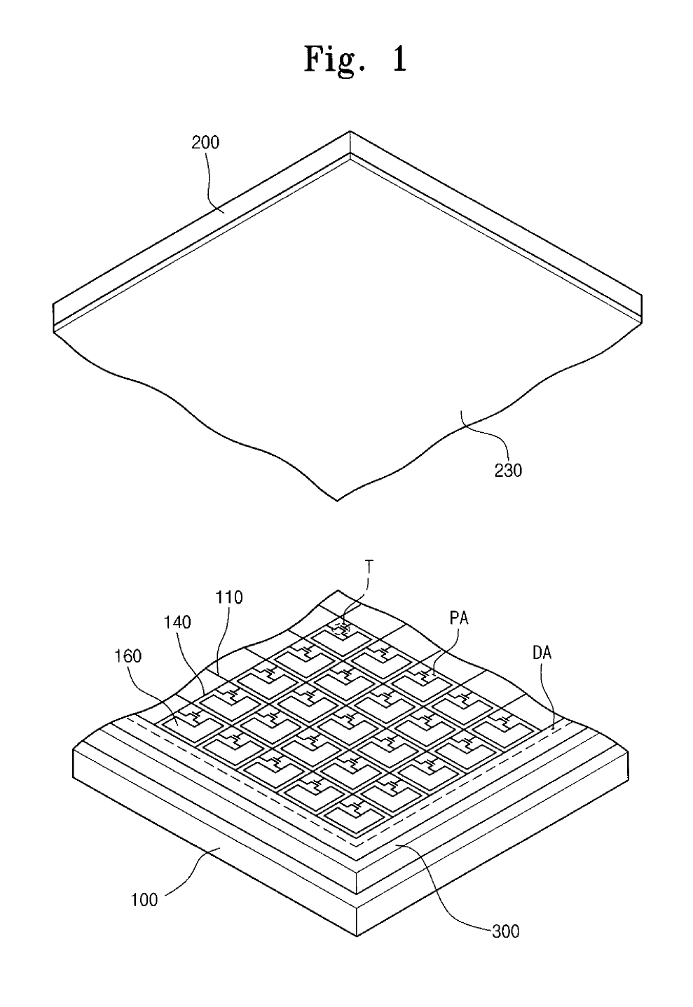

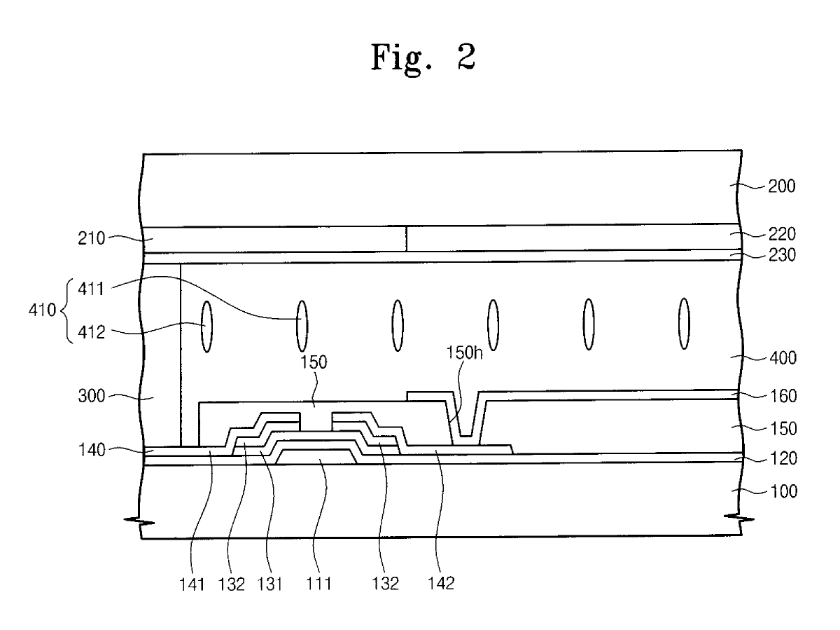

FIG. 1 is an exploded perspective view of an LCD according to an exemplary embodiment of the present invention. FIG. 2 is a sectional view showing a boundary portion of the display area DA of the LCD shown in FIG. 1.

Referring to FIG. 1 and FIG. 2, the LCD includes a first substrate 100 and a second substrate 200 facing the first substrate 100. A liquid crystal layer 400 is interposed between the first and second substrates 100 and 200. A display area DA, where an image is displayed, is defined on the first substrate 100. The display area DA includes the center portion of the first substrate 100, but not the peripheral portion of the first substrate 100.

A sealant pattern 300 is formed along the peripheral portion of the first substrate 100. The sealant pattern 300 may be formed on the second substrate 200 along the perimeter of the display area DA.

The first substrate 100 includes gate lines 110 and data lines 140 formed thereon. The gate lines 110 and data lines 140 are positioned in the display area DA. The gate lines 110 cross the data lines 140 to define pixel areas PA. A pixel electrode 160 and a thin film transistor T are provided in each pixel area PA.

The first and second substrates 100 and 200 are coupled together and spaced apart from each other due to the sealant pattern 300 arranged therebetween. The liquid crystal layer 400, including liquid crystal molecules 410, is aligned in the space between the first and second substrates 100 and 200.

The first substrate 100 includes the thin film transistors T. Each thin film transistor T includes a gate electrode 111, a source electrode 141, and a drain electrode 142. The gate electrode 111 branches from the gate line 110 and is formed on the first substrate 100. A gate insulating layer 120 is formed on the gate electrode 111 and covers the entire surface of the first substrate 100. A semiconductor pattern 131 and an ohmic contact pattern 132 are formed on the gate insulating layer 120 and overlap the gate electrode 111. The semiconductor pattern 131 may be an intrinsic semiconductor. The ohmic contact pattern 132 includes impurities and is divided into two parts. The source electrode 141 and the drain electrode 142 face each other and are formed along the two parts of the ohmic contact pattern 132, respectively. The source electrode 141 is connected to the data line 140.

The thin film transistors T are covered by a passivation layer 150, which includes contact holes 150h. The pixel electrodes 160, which are connected to the drain electrodes 142 through the contact holes 150h, are formed on the passivation layer 150.

The second substrate 200 includes a light blocking pattern 210, a color filter 220, and a common electrode 230. The light blocking pattern 210 includes an opening corresponding to the pixel area PA. The color filter 220 fills the opening in the light blocking pattern 210. The light blocking pattern 210 blocks light at the boundaries of the pixel areas PA, and the color filter 220 filters the light to display a color image. The common electrode 230 faces the pixel electrode 160 and is formed on the light blocking pattern 210 and the color filter 220.

Hereinafter, the operation of an LCD having the above structure will be described.

Referring to FIG. 1 and FIG. 2, during the operation of the LCD, a gate signal is applied to the gate line 110 to turn on the thin film transistor T. In addition, data signals corresponding to image information are transmitted to the data lines 140, so that data voltages corresponding to the data signals are applied to the respective pixel electrodes 160. A common voltage is applied to the common electrode 230. An electric field is formed due to the voltage difference between the pixel electrode 160 and the common electrode 230 and applied to the liquid crystal layer 400. Each liquid crystal molecule 410 included in the liquid crystal layer 400 has an oval shape and the alignment direction of the liquid crystal molecule 410 is defined according to the long-axis direction of the liquid crystal molecule 410. The liquid crystal molecules 410 have dielectric anisotropy so their alignment directions vary according to the electric field. In addition, the liquid crystal molecules 410 have refractive anisotropy, so the light transmittance varies according to the alignment of the liquid crystal molecules 410. The alignment directions of the liquid crystal molecules 410 are adjusted by controlling the intensity and direction of the electric field. As a result, an image corresponding to the alignment directions of the liquid crystal molecules 410 can be displayed using the light that passes through the liquid crystal molecules 410.

Since the LCD displays an image while controlling the alignment directions of the liquid crystal molecules 410, the image quality may deteriorate if the alignment directions of the liquid crystal molecules 410 deviate from the desired directions because of factors other than the electric field. The liquid crystal molecules 410 may be divided based on position into first liquid crystal molecules 411 positioned away from the peripheral portion of the display area DA and second liquid crystal molecules 412 position near the peripheral portion of the display area DA. The first liquid crystal molecules 411 can be aligned in the desired direction according to the electric field. However, the image quality may deteriorate in the area where the second liquid crystal molecules 412 are aligned as compared with the area where the first liquid crystal molecules 411 are aligned. This means that the second liquid crystal molecules 412 may be irregularly aligned because of factors other than the electric field.

The present exemplary embodiment provides a sealant pattern 300, which does not influence the alignment of the liquid crystal molecules 410 due to the components thereof.

Table 1 shows image quality results corresponding to various sealant samples. LCDs respectively including sealant samples S1, S2, S3, S4, S5, S6, S7, S8, S9, S10, S11, and S12, which each have various components, were prepared and the image quality of each LCD was tested. The sealant pattern 300 of each LCD was formed by curing the respective sealant.

TABLE 1

| Component | S1 | S2 | S3 | S4 | S5 | S6 | S7 | S8 | S9 | S10 | S11 | S12 |
|---|---|---|---|---|---|---|---|---|---|---|---|---|
| Acryl 1 | 15 | 0 | 35 | 15 | 15 | 15 | 15 | 15 | 15 | 15 | 15 | 15 |
| Acryl 2 | 20 | 35 | 0 | 45 | 20 | 20 | 20 | 20 | 20 | 20 | 20 | 20 |
| Acryl-epoxy | 25 | 25 | 25 | 0 | 25 | 25 | 25 | 25 | 25 | 25 | 25 | 25 |
| Photopolymerization | 3 | 3 | 3 | 3 | 0.3 | 3 | 3 | 3 | 3 | 3 | 3 | 3 |
| initiator | | | | | | | | | | | | |
| Coupling agent | 1.5 | 1.5 | 1.5 | 1.5 | 1.5 | 0 | 1.5 | 1.5 | 1.5 | 1.5 | 1.5 | 1.5 |
| Inorganic filler | 15 | 15 | 15 | 15 | 15 | 15 | 0 | 15 | 15 | 15 | 15 | 15 |
| Thermosetting agent A | 10.4 | 10.4 | 10.4 | 10.4 | 10.4 | 10.4 | 10.4 | 0 | 2.8 | | | |
| Thermosetting agent B | | | | | | | | | | 3.6 | | |
| Thermosetting agent C | | | | | | | | | | | 5.0 | 15 |
| Image quality | Bad | Bad | Bad | Bad | Bad | Bad | Bad | Good | Bad | Bad | Good | Good |

Referring to Table 1, the samples S1, S2, S3, S4, S5, S6, S7, S8, S9, S10, S11, and S12 each include a cured resin, a photopolymerization initiator, a coupling agent, an inorganic filler, and a thermosetting agent.

The cured resin may include a photo-cured resin, such as a UV-cured resin, and/or a thermosetting resin that is cured when heat is applied thereto. The cured resins used for the samples S1 S2, S3, S4, S5, S6, S7, S8, S9, S10, S11, and S12 include acryl-based compounds and epoxy-based compounds. The acryl-based compounds are mainly cured by light and the epoxy-based compounds are mainly cured by heat. The cured resins used for samples S1 S2, S3, S4, S5, S6, S7, S8, S9, S10, S11, and S12 include two types of acryl (acryl 1 and acryl 2), and acryl-epoxy compound.

Upon receiving light, the photopolymerization initiator generates an active radical while causing a polymerization reaction, thereby forming the cured resin. The photopolymerization initiator may be classified as a radical type photopolymerization initiator or an ion type photopolymerization initiator. With the ion type photopolymerization initiator, ions may penetrate into the liquid crystal layer 400 during the photo-curing process, so the liquid crystal molecules 410 may become contaminated. The radical type photopolymerization initiator may include benzylmethylketal, benzophenone, 1-hydroxycyclohexyl phenylketone, diethylthioxanthone, 2-ethylanthraquinone, or 2-hydroxy-2-methylpropiophenone.

The coupling agent may improve the adhesion strength of the sealant. The main component of the coupling agent may be a silane-based compound, such as 3-glycidoxypropyltrimethoxy silane, 3-glycidoxypropylmethyldimethoxy silane, 3-methacryloxypropyl trimethoxy silane, 3-chloromethyldimethoxy silane, or 3-chloropropyltrimethoxy silane.

The inorganic filler fills gaps between particles of the sealant to improve strength of the sealant. The inorganic filler may include silica, silicon carbide, silicon nitride, boron nitride, potassium carbonate, magnesium carbonate, calcium silicate, aluminum silicate, or glass fiber.

The thermosetting agent reacts with the cured resin to serve as a cross-linker for the cured resin. The thermosetting agent may include a dihydrazide compound. Samples S1 S2, S3, S4, S5, S6, S7, S8, S9, S10, S11, and S12 include three types of thermosetting agents, A, B, and C.

Referring to Table 1, sample S1 employs the acryl 1 compound, the acryl 2 compound, the acryl-epoxy compound, the photopolymerization agent, the coupling agent, the inorganic filler, and thermosetting agent A. The LCD employing sample S1 has degraded image quality. If the image quality degradation caused by the second liquid crystal molecules 412 is derived from the sealant pattern 300, the factor causing the image quality degradation is one of the acryl 1 compound, the acryl 2 compound, the acryl-epoxy compound, the photopolymerization agent, the coupling agent, the inorganic filler, and thermosetting agent A.

One of the acryl 1 compound, the acryl 2 compound, the acryl-epoxy compound, the photopolymerization agent, the coupling agent, the inorganic filler, and the thermosetting agent A is omitted in each of samples S2, S3, S4, S6, S7, and S8. Sample S5 includes only a small amount of photopolymerization agent. This is because the photo-curing may not be performed if the photopolymerization agent is completely omitted. When one of the acryl 1 compound, the acryl 2 compound, the acryl-epoxy compound, the photopolymerization agent, the coupling agent, and the inorganic filler is omitted in samples S2, S3, S4, S6, and S7, the image quality of the LCD is degraded. However, the LCD employing sample S8 displays a high-quality image.

From the above, it the acryl 1 compound, the acryl 2 compound, the acryl-epoxy compound, the photopolymerization agent, the coupling agent, and the inorganic filler are not factors causing image quality degradation. In addition, thermosetting agent A is a factor causing image quality degradation.

Sample S9 employs all of the acryl 1 compound, the acryl 2 compound, the acryl-epoxy compound, the photopolymerization agent, the coupling agent, the inorganic filler, and thermosetting agent A. However, the weight percent of thermosetting agent A is reduced as compared with that of sample S1. That is, the weight percent of thermosetting agent A in sample S9 is 2.8% as compared with the 10.4% of sample S1. Although the composition ratio of thermosetting agent A is reduced, the LCD using sample S9 exhibits image quality degradation. Therefore, thermosetting agent A may cause image quality degradation regardless of the quantity thereof.

Sample S10 employs the acryl 1 compound, the acryl 2 compound, the acryl-epoxy compound, the photopolymerization agent, the coupling agent, and the inorganic filler. In addition, sample S10 includes thermosetting agent B instead of thermosetting agent A. The LCD employing sample S10, which includes thermosetting agent B, has image quality degradation. Thus, it is understood that thermosetting agent B causes image quality degradation.

Samples S11 and S12 employ the acryl 1 compound, the acryl 2 compound, the acryl-epoxy compound, the photopolymerization agent, the coupling agent, the inorganic filler, and thermosetting agent C. In samples S11 and S12, the weight percent of thermosetting agent C is 5.0% and 15.0%, respectively. The LCDs employing sample S11 and sample S12 display high-quality images. Therefore, thermosetting agent C does not degrade image quality regardless of the quantity thereof.

Table 2 shows the structural formulas and physical properties of various thermosetting agents.

TABLE 2

| type | structural formula | melting point | image quality |
|---|---|---|---|
| thermosetting agent A | H2NHN—(C═O)—(CH2)4—(C═O)—NHNH2 | 182° C. | bad |
| thermosetting agent B | H2NHN—(C═O)—(CH2)8—(C═O)—NHNH2 | 191° C. | bad |
| thermosetting agent C | 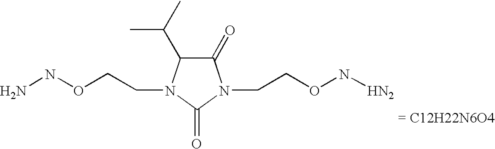 | 120° C. | good |
| thermosetting agent D | H2NHN—(C═O)—(CH2)2—(C═O)—NHNH2 | 167° C. | good |
| thermosetting agent E | H2NHN—(C═O)—(CH2)3—(C═O)—NHNH2 | 175° C. | good |

As shown in the test results obtained using samples S1, S2, S3, S4, S5, S6, S7, S8, S9, S10, S11, and S12 shown in Table 1, the image quality degradation of an LCD is caused by the thermosetting agent. In addition, thermosetting agents A and B may cause image quality degradation, and thermosetting agent C does not cause image quality degradation.

Hereinafter, components of the thermosetting agent causing image quality degradation will be analyzed. Referring to Table 2, the thermosetting agent includes a dihydrazide compound. Thermosetting agent A has a carbon chain that is coupled with NHNH₂ at both end portions thereof. A hydrocarbon having four carbons is positioned at the center the compound and carbons dual-bonded with oxygen are bonded to both ends of the hydrocarbon.

Thermosetting agent B has a carbon chain that is coupled with NHNH₂ at both end portions thereof. A hydrocarbon having eight carbons is positioned at the center of the compound and carbons dual-bonded with oxygen are bonded to both ends of the hydrocarbon.

Thermosetting agent C has a cyclic carbon compound at the center thereof, instead of a chain-type hydrocarbon, in which the cyclic carbon compound is obtained by replacing two carbon atoms of cyclopentane with nitrogen. Thermosetting agent C is different than thermosetting agents A and B in that thermosetting agent C has no carbon chain.

As described above with reference to Table 1, thermosetting agents A and B cause LCD image quality degradation, but thermosetting agent C does not cause LCD image quality degradation. That is, a thermosetting agent may cause LCD image quality degradation if there is a hydrocarbon chain in the thermosetting agent.

The above result is analyzed as follows. The liquid crystal molecules 410 include various compounds and some compounds may include a carbon chain. The carbon chain included in the liquid crystal molecules 410 may be influenced by the carbon chain included in thermosetting agent A or thermosetting agent B, so the carbon chain of the liquid crystal molecules 410 tends to be aligned corresponding to the carbon chain of thermosetting agent A or thermosetting agent B. Such a tendency may cause an anchoring force, thereby controlling the alignment of the liquid crystal molecules 410.

Referring to FIG. 2, the first liquid crystal molecules 411 are subject to an anchoring force caused by the electric field, but the second liquid crystal molecules 412 are subject to anchoring forces caused by both the electric field and the thermosetting agent. As a result, the second liquid crystal molecules 412 have an irregular alignment and the image quality is degraded in the corresponding areas.

Thermosetting agents D and E, according to the exemplary embodiment of the present invention, have structures similar to that of thermosetting agent A and thermosetting agent B. Thermosetting agent D includes a succinic dihydrazide compound. The succinic dihydrazide compound includes a carbon chain having four carbons. Thermosetting agent E includes a glutaric dihydrazide compound. The glutaric dihydrazide compound includes a carbon chain having five carbons. Since the number of carbons constituting the carbon chain is small in thermosetting agents D and E, the length of the carbon chain is short. Thus, the anchoring force of thermosetting agents D and E, which interferes with the alignment direction of the liquid crystal molecules 410, may be relatively weak.

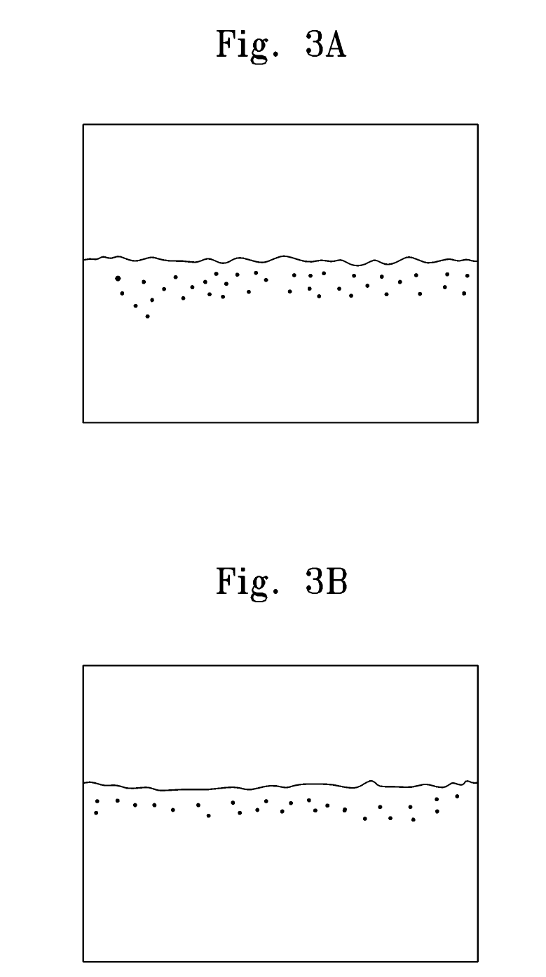

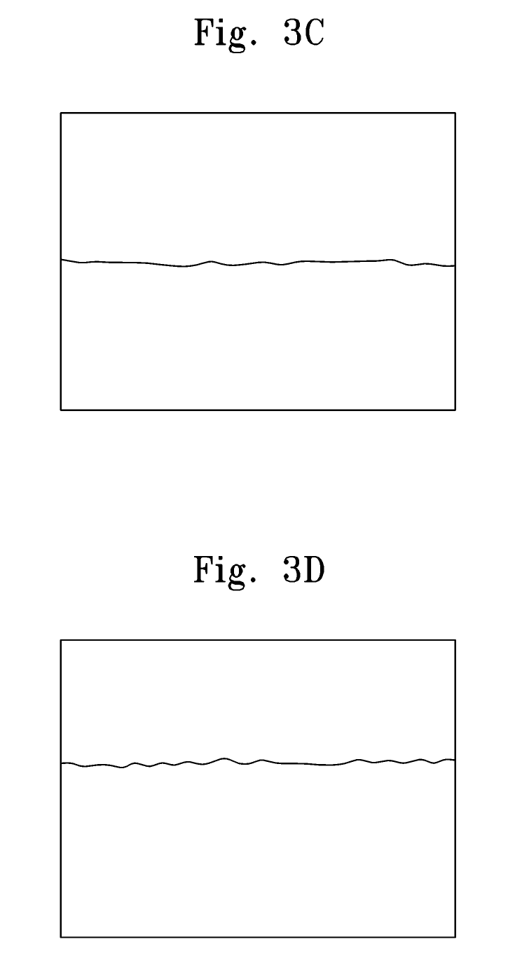

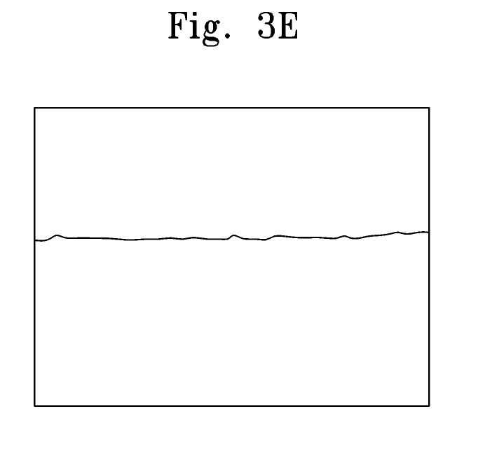

FIG. 3A, FIG. 3B, FIG. 3C, FIG. 3D, and FIG. 3E are enlarged photographic views showing boundary portions of display areas of LCDs according to exemplary embodiments and comparative examples of the prevent invention. FIG. 3A, FIG. 3B, FIG. 3D, and FIG. 3E are obtained from the LCD using thermosetting agents A, B, C, D, and E, respectively. In FIG. 3A, FIG. 3B, FIG. 3C, FIGS. 3D, and 3E, the upper portion corresponds to the sealant pattern, and the lower portion corresponds to the liquid crystal layer.

Referring to FIG. 3A and FIG. 3B, the portion corresponding to the liquid crystal layer 400 is not represented in a uniform state, and shows dark dots locally distributed. The dots signify the irregular alignment of the liquid crystal molecules 410.

Referring to FIG. 3C, FIG. 3D, and FIG. 3E, the portion corresponding to the liquid crystal layer 400 shows a uniform state, representing the uniform alignment of the liquid crystal molecules 410. Therefore, in the LCD employing a thermosetting agent having a carbon chain, the image quality degradation can be prevented by reducing the length of the carbon chain.

Referring to Table 2, the melting point of a thermosetting agent having a carbon chain is different than the melting point of a thermosetting agent having no carbon chain. In addition, the melting point of a thermosetting agent rises as the length of the carbon chain increases. Thermosetting agent C has a low melting point of 120° C. and has superior reactivity. Therefore, its viscosity rapidly increases at room temperature. For instance, if the sealant including thermosetting agent C is left at a temperature of about 25° C. for two days, the viscosity may increase from 300,000 cps to 400,000 cps, that is, the viscosity may increase by 33%. Thus, if the sealant including thermosetting agent C is transferred from a freezing chamber to a process chamber during the process of fabricating the LCD, the sealant may be used within 24 hours.

In this regard, a thermosetting agent having an excessively low melting point may have a viscosity that increases too rapidly. In contrast, if a thermosetting agent has an excessively high melting point, the reactivity thereof decreases. The melting point of the succinic dihydrazide compound is about 167° C., and the melting point of the glutaric dihydrazide compound is about 175° C. When the succinic dihydrazide compound and the glutaric dihydrazide compound are left at a temperature of about 25° C. for two days, the viscosities thereof are increased by about 12% and about 8%, respectively. Therefore, a thermosetting agent including the succinic dihydrazide compound or the glutaric dihydrazide compound may be used for a longer period of time. The melting point of a thermosetting agent is in a range of about 160° C. to about 180° C., within which the melting point of the succinic dihydrazide compound or the glutaric dihydrazide compound is established.

The dihydrazide compound serves as a cross-linker for the cured resin contained in the sealant. Since the dihydrazide compound is not a main component of the sealant, it may be sufficient even if a smaller amount of the dihydrazide compound is contained in the sealant. As shown in Table 1, about 10% by weight of the thermosetting agent is used for the sealant. However, the weight percent of the thermosetting agent may be increased or decreased, if necessary. For example, about 5% by weight to about 10% by weight of the thermosetting agent may be used for the sealant.

Hereinafter, the fabricating procedure for LCD using the sealant according to the exemplary embodiment will be described.

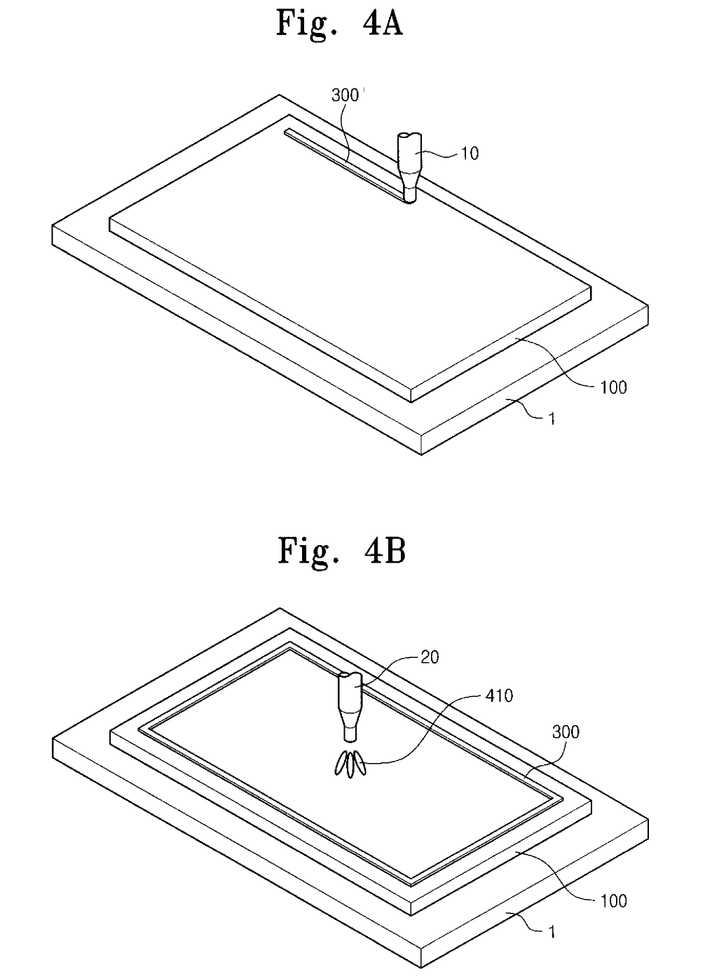

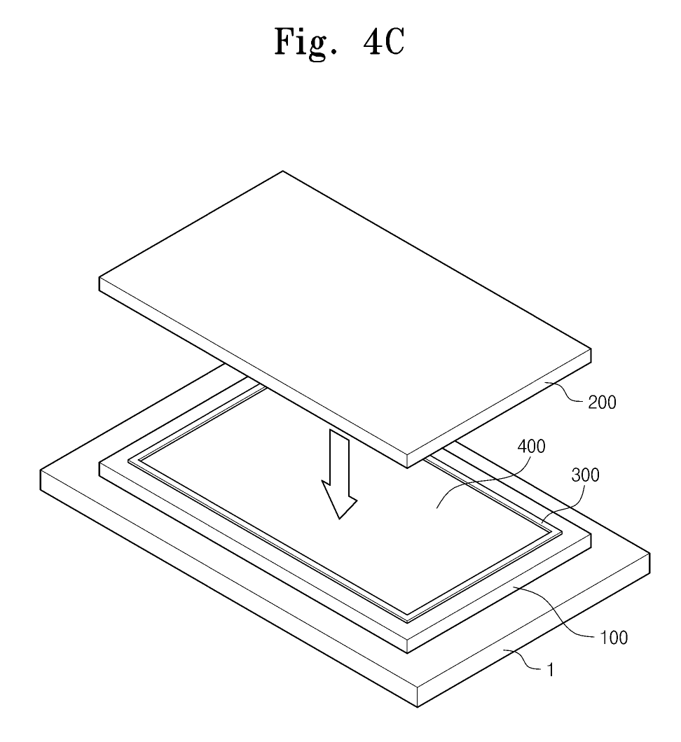

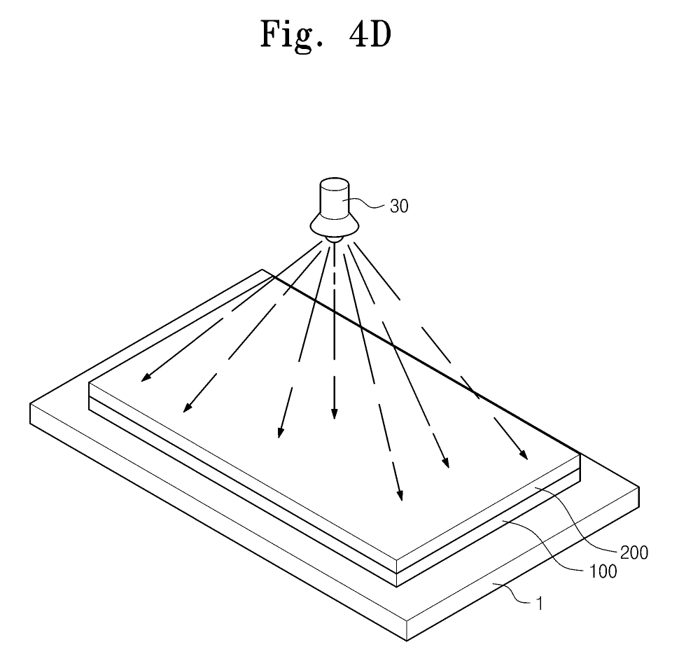

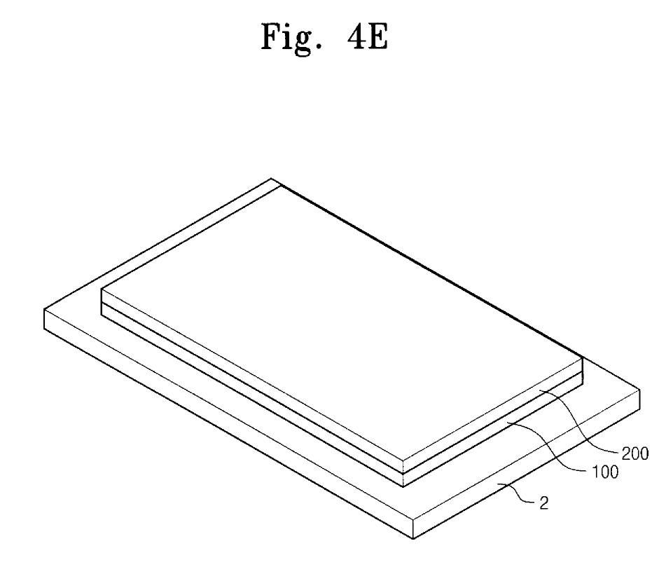

FIG. 4A, FIG. 4B, FIG. 4C, FIG. 4D, and FIG. 4E are views showing the method for fabricating the LCD shown in FIG. 1.

Referring to FIG. 4A, a first substrate 100 is placed on a stage 1. A first dispenser 10 is disposed and spaced apart from the first substrate 100. The first dispenser 10 is supplied with a sealant 300′ from a separate feeder and supplies the sealant 300′ to the first substrate 100 while moving along the peripheral portion of the first substrate 100. The sealant 300′ includes the cured resin, the photopolymerization initiator, the coupling agent, the inorganic filler, and a thermosetting agent. The thermosetting agent includes a succinic dihydrazide compound or a glutaric dihydrazide compound having a carbon chain with 5 or less carbon atoms.

Referring to FIG. 4B, a sealant pattern 300 is formed with the sealant 300′, which is supplied along the peripheral portion of the first substrate 100. A second dispenser 20 is disposed and spaced apart from the first substrate 100. The second dispenser 20 is supplied with liquid crystal molecules 410 from a separate feeder and supplies the liquid crystal molecules 410 to the first substrate 100. The liquid crystal molecules 410 are dropped onto an inner area surrounded by the sealant pattern 300.

A thermosetting agent including the succinic dihydrazide compound or the glutaric dihydrazide compound is suitable for the drop-filling type LCD. According to the drop-filling type LCD, the liquid crystal molecules 410 may be exposed to a thermosetting agent that has not been cured. That is, the liquid crystal molecules 410 adjacent to the sealant 300′ may be irregularly aligned due to a thermosetting agent that has not been cured. However, according to the exemplary embodiment of the present invention, the length of the carbon chain of the thermosetting agent is shortened, so the thermosetting agent does not exert an influence upon the alignment of the liquid crystal molecules 410. Thus, the liquid crystal molecules 410 may be uniformly aligned even if the drop-filling scheme is employed.

Referring to FIG. 4C, a second substrate 200 is disposed and faces the first substrate 100. A space corresponding to the height of the sealant pattern 300 separates the first and second substrates 100 and 200. The space is filled with the liquid crystal molecules 410, thereby forming the liquid crystal layer 400.

Referring to FIG. 4D, a light source 30 is provided on the top surface of the second substrate 200. Light generated from the light source 30 is irradiated to the first and second substrates 100 and 200. Thus, the photo-cured resin included in the sealant pattern 300 reacts with the light, thereby curing the resin.

Referring to FIG. 4E, the first and second substrates 100 and 200 are disposed on a hot plate 2. Heat is applied to the first and second substrates 100 and 200 from the hot plate 2, so that the first and second substrates 100 and 200 are heat-treated. The thermosetting resin contained in the sealant pattern 300 is cured by the heat.

As described above, according to the exemplary embodiments of the present invention, the liquid crystal molecules can be uniformly aligned so that the image quality of the LCD may be improved.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A sealant, comprising:
a thermosetting agent comprising a dihydrazide compound, which has a carbon chain with 5 or less carbon atoms; and
a cured resin.

2. The sealant of claim 1, wherein the dihydrazide compound has a chemical formula as follows:
H₂NHN—(C=0)-R—(C=0)-NHNH₂, R: hydrocarbon.

3. The sealant of claim 2, wherein the dihydrazide compound comprises a succinic dihydrazide compound.

4. The sealant of claim 2, wherein the dihydrazide compound comprises a glutaric dihydrazide compound.

5. The sealant of claim 1, wherein the dihydrazide compound has a weight percent of 5% to 20%.

6. The sealant of claim 1, wherein the dihydrazide compound has a melting point in a range of 160° C. to 180° C.

7. The sealant of claim 1, wherein the cured resin comprises an acryl-based resin and an epoxy-based resin.

8. The sealant of claim 7, further comprising a photopolymerization initiator, a coupling agent, and an inorganic filler.

9. A liquid crystal display, comprising:
a first substrate;
a second substrate facing the first substrate;
liquid crystal molecules interposed between the first substrate and the second substrate; and
a sealing pattern disposed along a peripheral portion of the first substrate to couple the first substrate and the second substrate,
wherein the sealing pattern is formed from a sealant, and the sealant comprises a thermosetting agent comprising a dihydrazide compound, which has a carbon chain with 5 or less carbon atoms, and a cured resin.

10. The liquid crystal display of claim 9, wherein the dihydrazide compound has a chemical formula as follows:
H₂NHN—(C=0)-R—(C=0)-NHNH₂, R: hydrocarbon.

11. The liquid crystal display of claim 10, wherein the dihydrazide compound comprises a succinic dihydrazide compound.

12. The liquid crystal display of claim 10, wherein the dihydrazide compound comprises a glutaric dihydrazide compound.

13. The liquid crystal display of claim 9, wherein the dihydrazide compound has a weight percent of 5% to 20%.

14. The liquid crystal display of claim 9, wherein the dihydrazide compound has a melting point in a range of 160° C. to 180° C.

15. The liquid crystal display of claim 9, wherein the cured resin comprises an acryl-based resin and an epoxy-based resin.

16. The liquid crystal display of claim 15, further comprising a photopolymerization initiator, a coupling agent, and an inorganic filler.

17. A method of fabricating a liquid crystal display, comprising:
coating a sealant along a peripheral portion of a first substrate to form a sealant pattern;
dropping liquid crystal molecules onto the first substrate;
aligning a second substrate on the first substrate; and
curing the sealing pattern to couple the first substrate and the second substrate,
wherein the sealant comprises a thermosetting agent comprising a dihydrazide compound, which has a carbon with 5 or less carbon atoms, and a cured resin.

18. The method of claim 17, wherein the dihydrazide compound has a chemical formula as follows:
H₂NHN—(C=0)-R—(C=0)-NHNH₂, R: hydrocarbon.

19. The method of claim 18, wherein the dihydrazide compound comprises a succinic dihydrazide compound.

20. The method of claim 18, wherein the dihydrazide compound comprises a glutaric dihydrazide compound.
